(19) United States
(12) Patent Application Publication
(10) Pub. No.: US 2025/0166215 A1
(43) Pub. Date: May 22, 2025

(54) METHODS FOR DETERMINING THE SIZE AND DENSITY OF A LESION FROM A MEDICAL IMAGING SCAN

(71) Applicant: Brainomix Limited, Oxford (GB)

(72) Inventors: Luca PUVIANI, Oxford (GB); Wassim BOU-ZEID, Oxford (GB); Olivier JOLY, Oxford (GB)

(21) Appl. No.: 18/953,501

(22) Filed: Nov. 20, 2024

(30) Foreign Application Priority Data
Nov. 21, 2023 (GB) 2317773.6

(51) Int. Cl. G06T 7/62; G06T 7/00; G06T 7/11; G06T 7/149; G06T 7/174

(52) U.S. Cl. CPC G06T 7/62; G06T 7/0012; G06T 7/11; G06T 7/149; G06T 7/174; G06T 2207/30096; G06T 2210/12

(57) ABSTRACT

Computer-implemented methods for determining the size of a lesion, and/or an indication of density of the lesion, from a set of images corresponding to a scan of a patient's anatomy are disclosed. In particular, a method is disclosed for determining the size of a lesion from a scan by generating a final segmentation mask to identify an area within a scan image comprising the lesion based on combining a plurality of segmentation masks to satisfy at least one rule. Another method is disclosed for determining the size of a lesion from a scan by generating a final segmentation mask for a scan image based on weightings of superpixels within that scan image. Another method is also disclosed for determining the size of a lesion from a scan by generating a final segmentation mask for a scan image based on pixel clustering and determining for each pixel cluster whether the pixel cluster should form a part of the final segmentation mask.

### CROSS REFERENCE TO RELATED APPLICATIONS

The present application claims priority to United Kingdom patent application No. 2317773.6, filed Nov. 21, 2023.

### FIELD OF THE INVENTION

The present disclosure relates to computer-implemented methods for determining the size and/or volume of a lesion, and/or an indication of density of the lesion, from a scan, in particular from a scan wherein each image from the scan corresponds to a cross-sectional slice of a patient's anatomy.

### BACKGROUND

Conventional methods for determining the area of a lesion based on medical image segmentation often rely heavily on aligning algorithms directly with human-segmented Ground Truth (GT) data. However, the availability of GT data is limited and often of suboptimal quality, for example due to over-segmentations, under-segmentations, and inconsistencies among slices.

Acquiring high-quality human-labelled GTs is both time-consuming and costly. For example, achieving consensus among three radiologists for segmenting even a single clinical dataset can take years and cost hundreds of thousands of pounds.

Current leading artificial intelligence (AI) methods require numerous GTs and are often ineffective for lesions such as tumours due to vast variability in lesion shapes, and intra-lesion texture variations, etc. Traditional computer vision methods also fall short due to the high variability in tumour shape, texture, and their connections with other anatomical structures.

There is therefore a need to develop improved methods for determining the area of a lesion that reduce or eliminate dependence on human-segmented GTs.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

In a first aspect of the invention there is provided a computer-implemented method for determining the area of a lesion from a scan of at least a part of a patient's anatomy. The method comprises:
(a) obtaining at least one image based on a scan of at least a part of a patient's anatomy;
(b) applying a plurality of different segmentation techniques to the at least one image to generate a plurality of segmentation masks, wherein each segmentation technique is configured to generate a segmentation mask to identify an area within the at least one image comprising a lesion;
(c) generating a final segmentation mask to identify a final area within the at least one image comprising the lesion, based on combining the plurality of segmentation masks to satisfy at least one rule; and
(d) segmenting the at least one image using the final segmentation mask to define the area of a lesion within the at least one image.

By combining a plurality of segmentation masks to satisfy at least one rule, the method may generate a more reliable composite mask. This method may be advantageous as it allows a final segmentation to be generated by combining a plurality of segmentation masks to satisfy at least one rule, thereby avoiding the reliance on ground truth data which is required for the training of conventional machine learning (ML) based approaches.

Applying the plurality of different image segmentation techniques may comprise applying a plurality of different computer vision techniques and/or algorithms for image segmentation. However, the skilled person will understand that alternative image segmentation techniques, such as but not limited to level set segmentation, may also be used.

Each of the plurality of segmentation masks may be configured to be different, for example wherein each segmentation mask identifies a different area within the at least one image which comprises the lesion. However, the skilled person will understand that areas identified by the different segmentation masks may at least partially overlap. In some instances, the skilled person will understand that different segmentation techniques may yield the same or substantially the same segmentation masks.

Generating the final segmentation mask may comprise combining the plurality of segmentation masks using a genetic algorithm to satisfy the at least one rule. By integrating multiple masks using a genetic optimisation algorithm, this method may advantageously achieve nuanced segmentation without the typical reliance on ground truth data.

In some examples, generating the final segmentation mask may comprise combining the plurality of segmentation masks to satisfy a set of rules. The set of rules may comprise static and/or dynamic constraints. Static constraints comprise rules that do not change during the generation of the segmentation mask. Dynamic constraints comprise rules that may adapt based on the characteristics of the image and segmentation during the generation process. A segmentation mask may be defined as a portion of an image that is isolated from the rest of the image.

The method may further comprise obtaining a bounding box for the at least one image, wherein the bounding box defines a perimeter bounding an area of the at least one image which comprises the lesion. The plurality of segmentation masks may be applied to the area defined by the bounding box, such that each segmentation mask is configured to identify an area within the bounding box comprising the lesion.

Obtaining a bounding box may be advantageous to identify an area of the scan reliably containing the lesion. A bounding box may also be advantageous to ensure that the lesion consistently occupies a substantially central position within the bounding box. A central position may be advantageous when applying the plurality of segmentation techniques to the bounding box to improve the accuracy of the lesion segmentation, compared to applying the plurality of segmentation techniques to the entirety of the scan as a whole.

The bounding box may be obtained by human input, for example by a radiologist, or by automated bounding box detection methods, for example based on object detection algorithms.

Obtaining the at least one image may comprise obtaining a plurality of images based on a scan of at least a part of a patient's anatomy, each image corresponding to a cross-sectional slice from the scan. For example, the scan may be, but is not limited to, a computed tomography (CT) scan, or magnetic resonance imaging (MRI) scan. The method may further comprise repeating steps (b) to (d) for each of the plurality of images. In some examples, the obtained plurality of images may be based on a scan of at least a part of a patient's lung, such as but not limited to a CT scan of a patient's lung.

In embodiments comprising a plurality of images, such as a set of scan images, the method may further comprise tracking and resizing the bounding box for each image or “slice” to ensure the lesion retains a substantially central positioning within the bounding box. For example, in the manual measurement of lesion size based on the Response Evaluation Criteria In Solid Tumors (RECIST), radiologists commonly measure the largest diameter of a lesion on the slice where it visually appears with the greatest extent among all slices. This specific cross-sectional slice or image serves as a reference slice, from which the method proceeds in two directions: moving forward and moving backward. As the method progresses through the slices, a sizing constraint may be employed to ensure that the bounding box and/or segmented area for a given slice typically remains smaller or at least equivalent to the previous slice's area. Notably, if there's an expansion in the segmented area across consecutive slices, it may indicate difficulties in differentiating lesion tissue from neighbouring tissue structures. This constraint may be advantageous to halt further segmentation in this instance to avoid discrepancies in the final area and/or volume estimations.

In some examples, the plurality of segmentation masks may be combined in the same way to generate the final segmentation mask for each image in the set of images. This may be advantageous to reduce computing power and time, and to fine-tune the segmentation process. Alternatively, the plurality of segmentation masks may be combined in a manner optimised for each image in order to generate the final segmentation mask, for example using a genetic optimisation algorithm for each image. This may be advantageous to obtain a more reliable and accurate final segmentation across the plurality of images.

The at least one rule, or at least one rule of the set of rules, may comprise a boundary constraint configured to ensure that the final segmentation mask is configured such that the final area defined by the final segmentation mask does not contact or intersect the perimeter of the bounding box. This may be advantageous to ensure that the bounding box around the lesion on the reference slice is not oversaturated.

The at least one rule, or at least one rule of the set of rules, may comprise an area continuity constraint configured to ensure that the area of a lesion segmented from a second image of the set of images is less than or equal to the area of the lesion segmented from a first image of the set of images, wherein the first image and the second image are adjacent cross-sectional slices from the scan, and wherein the first image is obtained closer to the centroid of the lesion and/or the reference slice than the second image. For example, the area continuity constraint configured may be configured to minimise area penalties, wherein area penalties are incurred for segmentation masks wherein the area of a lesion segmented from a second image is greater than the area of the lesion segmented from a first image. This may be advantageous as lesions are generally largest at the centre and have a reducing cross-sectional area, thus applying such an area continuity constraint may improve accuracy and reliability of the segmentation.

The at least one rule, or at least one rule of the set of rules, may comprise a centroid proximity constraint configured to ensure that the centroid of a lesion segmented from the final mask is maintained within a defined distance relative to the centroid of the lesion segmented from at least one of the plurality of segmentation masks. This may be advantageous to improve accuracy of the final mask generation to ensure that the centroid of the lesion segmented by the final generated mask does not significantly vary from the at least one of the plurality of segmentation masks.

Generating the final segmentation mask may comprise obtaining a similarity score configured to measure the similarity between the final segmentation mask and at least one of the plurality of segmentation masks. The at least one rule, or at least one rule of the set of rules, may comprise a similarity score constraint configured to ensure that the obtained similarity score is above a predetermined threshold or within a predetermined range. This may be advantageous to improve accuracy of the final mask generation to ensure that the final generated mask does not significantly vary from the at least one of the plurality of segmentation masks. In some examples, the similarity score may be, but is not limited to, a Dice score (also known as a Sørensen-Dice coefficient).

The method may also comprise generating an Adaptive Chan-Vese mask derived by computing (or re-computing) a Chan-Vese segmentation within the bounds of the final segmentation mask. A similarity score, such as but not limited to a DICE score, between the adaptive Chan-Vese mask and the generated final segmentation mask may then be obtained. This may be advantageous to provide an internal consistency measure, ascertaining the robustness of the generated final segmented output. This similarity score may be compared to a predetermined range or threshold to determine whether the consistency between the adaptive Chan-Vese mask and the generated final segmentation mask is acceptable. If the similarity of the adaptive Chan-Vese mask and the generated final segmentation mask is acceptable, the final segmentation mask may be accepted, and the optimisation of such may cease. If not, optimisation of the final segmentation mask may continue to iterate, for example via genetic optimisation.

The at least one rule, or at least one rule of the set of rules, may comprise a mask containment constraint, wherein the mask containment constraint is configured to ensure that the final segmentation mask must be confined within the area of at least one of the plurality of segmentation masks. This may be advantageous to improve the accuracy of the final mask generation by ensuring that the final mask is confined with the area of at least one of the plurality of segmentation masks, preferably wherein the at least one of the plurality of segmentation masks which confines the final segmentation mask arises from a “coarse” segmentation technique configured to delineate tissue types of interest. This may be advantageous to prevents the final mask from including areas of the image which were identified to be irrelevant tissue types by the at least one confining segmentation masks.

The at least one rule, or at least one rule of the set of rules, may comprise a shape integrity constraint configured to ensure that irregular boundaries representing outgrowths in shape of a lesion segmented from an image are minimised, such that the shape integrity constraint is configured to promote smooth and regular lesion shapes segmented from an image.

In some examples, the obtained at least one image may be, but is not limited to be, based on a scan of at least a part of a patient's lung. For example, a first segmentation technique of the plurality of segmentation techniques may be configured to generate a first segmentation mask to delineate parenchyma from other lung tissue. The at least one rule, or at least one rule of the set of rules, may comprise a mask containment constraint, wherein the mask containment constraint is configured to ensure that the final segmentation mask must be confined within the area of the first mask. This may be advantageous to improve the accuracy of the final mask generation by ensuring that the final mask is confined with the area of the first mask which identifies other lung tissue, and prevents the final mask from including areas of the image which were identified to be parenchyma by the first mask. An example first segmentation technique may include, but is not limited to, K-means segmentation, wherein the first mask is a K-means mask. The K-means segmentation may be advantageous to delineate tissues from parenchyma, and thus set a foundational boundary within which the lesion invariably resides. However, the skilled person will understand that other segmentation techniques configured to delineate parenchyma from other lung tissue may be used.

In some examples, the plurality of segmentation masks may comprise three different segmentation masks. For example, the plurality of segmentation techniques may comprise three different segmentation techniques. This may be advantageous as too few segmentation techniques may result in a less accurate final segmentation mask, however too many segmentation techniques and/or masks requires excessive computing power and time to generate the final segmentation mask. However, the skilled person will understand that other numbers of segmentation techniques may be used, for example but not limited to more than three segmentation techniques. It is noted that it is not a requirement of the invention to generate a final segmentation mask with 100% accuracy to identify the lesion, rather the present invention may be configured to generate a final segmentation mask with an acceptable error margin, such as a 10% error margin.

The method may further comprise determining the area of the lesion based on the segmented area of the at least one image. This may be determined by calculating the area of the final segmentation mask identifying the lesion (either in pixels, or as a physical area by multiplying by the pixel area in e.g. square millimetres).

In embodiments comprising obtaining a plurality of images, each image corresponding to a cross-sectional slice from the scan, the method may then further comprise determining the volume of the lesion based on the segmented area of the lesion in each of the plurality of segmented images. This may comprise summing the areas of the final segmentation mask for each image, and optionally computing a physical volume by multiplying by pixel area and slice thickness (i.e. the distance between consecutive cross-sectional images). Alternatively, the method may further comprise generating a three-dimensional model of the lesion based on the plurality of segmented images, and determining the volume of the lesion based on the three-dimensional model of the lesion.

In some examples, the method may further comprise applying a weighting to each pixel within the segmented area of the at least one segmented image, wherein the weighting is based on the relative intensity of each pixel within the segmented area, and determining an indication of mass of the lesion based on the weightings applied to each pixel within the segmented area of the at least one segmented image. This may be advantageous to provide an indication of lesion density. Lesion density can be an important measurement parameter, in particular many targeted drugs may impact tumour density. As such, quantifying and measuring tumour density can provide important insight into the efficacy of such drugs during treatment as in some instances tumour volume may be relatively unaffected despite changes in tumour density within the volume due to the effect of these drugs.

Additionally, applying a weighting to each pixel and determining an indication of mass may reduce some of the oversegmentation errors, especially in non-solid areas which may be assigned a lower weighting. In essence, instead of viewing a segmented area with uniform and unitary weight (“volume”), the method may measure “effective volume” (a surrogate for mass), which weighs each pixel based on its relative intensity compared to the maximum intensity within that tumour.

Alternatively, the computer-implemented method provided for determining the area of a lesion from a scan of at least a part of a patient may comprise:
obtaining a plurality of images based on a scan of a part of a patient's anatomy, each image corresponding to a cross-sectional slice from the scan;
for each image, applying a plurality of segmentation masks to each image, wherein each segmentation mask is different;
for each image, generating a final segmentation mask based on combining the plurality of segmentation masks to satisfy at least one rule; and
segmenting each image using the corresponding final segmentation mask to define the area of a lesion within the image.

The skilled person will understand that all features disclosed with regard to the preceding aspect of the invention may also apply to this method.

For example, the method may further comprise determining the volume of the lesion based on the segmented area of the lesion in each of the plurality of segmented images and/or the plurality of final segmentation masks. This may comprise summing the areas of the final segmentation mask for each image, optionally accounting for slice thickness (i.e. the distance between consecutive cross-sectional images). Alternatively, the method may further comprise generating a three-dimensional model of the lesion based on the plurality of segmented images, and determining the volume of the lesion based on the three-dimensional model of the lesion.

In some examples, the method may further comprise applying a weighting to each pixel within the segmented area of the at least one segmented image, wherein the weighting is based on the relative intensity of each pixel within the segmented area, and determining an indication of mass of the lesion based on the weightings applied to each pixel within the segmented area of the at least one segmented image. This may be advantageous to provide an indication of lesion density. Additionally, applying a weighting to each pixel and determining an indication of mass may reduce some of the oversegmentation errors, especially in non-solid areas which may be assigned a lower weighting.

In another aspect of the invention, there is provided a computer-implemented method for determining the area of a lesion from a scan of at least a part of a patient. The method comprises:
(a) obtaining at least one image based on a scan of at least a part of a patient's anatomy;
(b) segmenting the at least one image into a plurality of superpixels;
(c) applying a weighting to each superpixel, wherein the weighting corresponds to the likelihood of the superpixel comprising lesional tissue;
(d) generating a final segmentation mask for the image, based on optimising at least one mask constraint, wherein the at least one mask constraint is based on the weighting each superpixel within the final segmentation mask; and
(e) segmenting the image using the final segmentation mask to define the area of a lesion within the image.

As with the first aspect of the invention, this method may be advantageous as it allows a final segmentation to be generated based on segmenting and weighting superpixels to determine a final segmentation mask, thereby avoiding the reliance on ground truth data which is required for the training of conventional machine learning (ML) based approaches.

A superpixel may be defined as a group of pixels that share common characteristics, for example but not limited to intensity and/or texture properties. For example, segmenting the at least one image into the plurality of superpixels may be based on, but is not limited to, clustering pixels based on at least one of (i) colour similarity and (ii) proximity in the image plane.

Purely as an example, segmenting the at least one image into the plurality of superpixels may comprise, but is not limited to, applying a simple linear iterative clustering, SLIC, algorithm to the at least one image.

Generating the final segmentation mask for the image may comprise iteratively refining the final segmentation mask to optimise the at least one mask constraint. Optimising the at least one mask constraint may comprise iteratively reducing a penalty score associated with the aggregate weighting of a final segmentation mask, or increasing a confidence score based on the aggregate weighting of a final segmentation mask. The iterative process may cease or terminate when a penalty score or confidence score reaches/traverses a predetermined threshold or range. Alternatively, or in addition, the iterative process may cease or terminate in accordance with any other termination criteria or termination rule(s).

The method may further comprise obtaining a bounding box for the at least one image, wherein the bounding box defines a perimeter of an area which comprises the lesion within the at least one image. The bounding box may be obtained by human input, for example by a radiologist, or by automated bounding box detection, for example based on object detection. Segmenting the at least one image into the plurality of superpixels may comprise segmenting the area of the at least one image defined by the bounding box into a plurality of superpixels.

Applying the weighting to each superpixel may be based on the relative position of each superpixel. In particular, applying the weighting to each superpixel may be based on the relative position of each superpixel within the bounding box. Obtaining a bounding box may be advantageous to identify an area of the scan reliably containing the lesion. A bounding box may also be advantageous to ensure that the lesion consistently occupies a substantially central position within the bounding box.

For example, applying the weighting to each superpixel may be based on proximity of the superpixel to the centre of the bounding box. This may be advantageous as the lesion may be statistically most likely to be located relatively central to the bounding box. For example, superpixels arranged close to the centre of the bounding box may be weighted to be more likely to comprise lesional tissue compared to superpixels arranged further from the centre of the bounding box. Alternatively or in addition, applying the weighting to each superpixel may be based on proximity of the superpixel to the perimeter of the bounding box, for example wherein superpixels arranged close to the perimeter of the bounding box are weighted to be less likely to comprise lesional tissue than superpixels arranged further from the perimeter of the bounding box.

In embodiments comprising a plurality of images, such as a set of scan images, the method may further comprise tracking and resizing the bounding box for each image or “slice” to ensure the lesion retains a substantially central positioning within the bounding box. For example, starting from the slice with largest lesion diameter as a reference, the method may sequentially navigate in two directions: moving forward from the reference slice, and proceeding in the reverse from the reference slice. As the method progresses through the slices, a sizing constraint may be employed to ensure that the bounding box and/or segmented area for a given slice typically remains smaller or at least equivalent to the previous slice's area. Notably, if there's an expansion in the segmented area across consecutive slices, it may indicate difficulties in differentiating lesion tissue from neighbouring tissue structures. This constraint may be advantageous to halt further segmentation in this instance to avoid discrepancies in the final area and/or volume estimations.

The at least one image may be segmented into a predetermined number of superpixels. This may be advantageous to ensure a consistent number of superpixels within the bounding box, and may reduce oversegmentation or undersegmentation errors caused by significantly fluctuating numbers of superpixels. For example, the at least one image may be segmented into 250 superpixels within the bounding box, however the skilled person will understand that this is not limiting and any other number of superpixels may be used.

Obtaining at least one image may comprise obtaining a plurality of images based on a scan of at least a part of a patient's lung, each image corresponding to a cross-sectional slice from the scan, such as a CT or MRI scan. The method may further comprise repeating steps (b) to (e) for each of the plurality of images.

In some examples, the at least one mask constraint for generating the final segmentation mask for the image is based on at least one of:
(i) expansion-based mask generation, configured to generate the final segmentation mask to define the area of a lesion based on adding superpixels to the mask based on the weighting of each superpixel within the image; and
(ii) reduction-based mask generation, configured to generate the final segmentation mask to define the area of a lesion based on removing superpixels from the mask based on the weighting of each superpixel within the image.

Generating the final segmentation mask for the image may be based on synergistically applying both expansion-based mask generation and reduction-based mask generation to generate the final segmentation mask. For example, both expansion-based mask generation and reduction-based mask generation may be employed for a given image in parallel, wherein the resulting expansion-based mask and reduction-based mask may then be combined or merged to generate the final segmentation mask.

Generating the final segmentation mask for the image may, additionally or instead, be based on satisfying at least one rule or a set of rules.

The at least one rule, or at least one rule of the set of rules, may comprise a boundary constraint configured to ensure that the final segmentation mask is configured such that the final area defined by the final segmentation mask does not contact or intersect the perimeter of the bounding box. This may be advantageous to ensure that the reference bounding box is not oversaturated.

The at least one rule, or at least one rule of the set of rules, may comprise a centroid proximity constraint configured to ensure that the centroid of a lesion segmented from the final mask is maintained within a defined distance relative to the centroid of the lesion segmented from at least one of the plurality of segmentation masks. This may be advantageous to improve accuracy of the final mask generation to ensure that the centroid of the lesion segmented by the final generated mask does not significantly vary from the at least one of the plurality of segmentation masks.

The at least one rule, or at least one rule of the set of rules, may comprise an area continuity constraint configured to ensure that the area of a lesion segmented from a second image is less than or equal to the area of the lesion segmented from a first image, wherein the first image and the second image are adjacent cross-sectional slices from the scan, and wherein the first image is obtained closer to the centroid of the lesion and/or the reference slice than the second image. For example, the area continuity constraint configured may be configured to minimise area penalties, wherein area penalties are incurred for segmentation masks wherein the area of a lesion segmented from a second image is greater than the area of the lesion segmented from a first image. This may be advantageous as lesions are generally largest at the centre and have a reducing cross-sectional area, thus applying such an area continuity constraint may improve accuracy and reliability of the segmentation.

The at least one rule, or at least one rule of the set of rules, may comprise a shape integrity constraint configured to ensure that irregular boundaries representing outgrowths in shape of a lesion segmented from an image are minimised, such that the shape integrity constraint is configured to promote smooth and regular lesion shapes segmented from an image.

The method may further comprise determining the area of the lesion based on the segmented area of the at least one image. This may be determined by calculating the area of the final segmentation mask identifying the lesion.

In embodiments comprising obtaining a plurality of images, each image corresponding to a cross-sectional slice from the scan, the method may then further comprise determining the volume of the lesion based on the segmented area of the lesion in each of the plurality of segmented images. This may comprise summing the areas of the final segmentation mask for each image, optionally accounting for slice thickness (i.e. the distance between consecutive cross-sectional images). Alternatively, the method may further comprise generating a three-dimensional model of the lesion based on the plurality of segmented images, and determining the volume of the lesion based on the three-dimensional model of the lesion.

In some examples, the method may further comprise applying a weighting to each pixel within the segmented area of the at least one segmented image, wherein the weighting is based on the relative intensity of each pixel within the segmented area, and determining an indication of mass of the lesion based on the weightings applied to each pixel within the segmented area of the at least one segmented image. This may be advantageous to provide an indication of lesion density. Lesion density can be an important measurement parameter, in particular many targeted drugs may impact tumour density. As such, quantifying and measuring tumour density can provide important insight into the efficacy of such drugs during treatment as in some instances tumour volume may be relatively unaffected despite changes in tumour density within the volume due to the effect of these drugs.

Additionally, applying a weighting to each pixel and determining an indication of mass may reduce some of the oversegmentation errors, especially in non-solid areas which may be assigned a lower weighting. In essence, instead of viewing a segmented area with uniform and unitary weight (“volume”), the method may measure “effective volume” (a surrogate for mass), which weighs each pixel based on its relative intensity compared to the maximum intensity within that tumour.

Alternatively, the computer-implemented method provided for determining the area of a lesion from a scan of at least a part of a patient may comprise:
(a) obtaining a plurality of images based on a scan of a part of a patient's anatomy, each image corresponding to a cross-sectional slice from the scan;
(b) for each image, segmenting the image into a plurality of superpixels;
(c) for each image, applying a weighting to each superpixel, wherein the weighting corresponds to the likelihood of the superpixel comprising lesional tissue;
(d) for each image, generating a final segmentation mask for the image, based on optimising at least one mask constraint, wherein the at least one mask constraint is based on the weighting each superpixel within the final segmentation mask; and
(e) for each image, segmenting the image using the final segmentation mask to define the area of a lesion within the image.

The skilled person will understand that all features disclosed with regard to the preceding aspect of the invention may also apply to this method.

For example, the method may further comprise determining the volume of the lesion based on the segmented area of the lesion in each of the plurality of segmented images and/or the plurality of final segmentation masks. This may comprise summing the areas of the final segmentation mask for each image, optionally accounting for slice thickness (i.e. the distance between consecutive cross-sectional images). Alternatively, the method may further comprise generating a three-dimensional model of the lesion based on the plurality of segmented images, and determining the volume of the lesion based on the three-dimensional model of the lesion.

In some examples, the method may further comprise applying a weighting to each pixel within the segmented area of the at least one segmented image, wherein the weighting is based on the relative intensity of each pixel within the segmented area, and determining an indication of mass of the lesion based on the weightings applied to each pixel within the segmented area of the at least one segmented image. This may be advantageous to provide an indication of lesion density. Additionally, applying a weighting to each pixel and determining an indication of mass may reduce some of the oversegmentation errors, especially in non-solid areas which may be assigned a lower weighting.

In another aspect of the invention, there is provided a computer-implemented method for determining the area of a lesion from a scan of at least a part of a patient, the method comprising:
(a) obtaining at least one image based on a scan of at least a part of a patient's anatomy;
(b) applying a first binary segmentation technique to the at least one image to generate a first binary mask, the first binary mask delineating a first set of pixels within the at least one image, the first set of pixels corresponding to a first area within the at least one image comprising a lesion;
(c) grouping the first set of pixels into a plurality of pixel clusters, based on the relative proximity of each pixel within the first set of pixels;
(d) generating a final segmentation mask, based on determining for each pixel cluster whether the pixel cluster should form a part of the final segmentation mask; and
(e) segmenting the at least one image using the final segmentation mask to define the area of a lesion within the at least one image.

Again, this method may be advantageous as it allows a final segmentation to be generated based on iteratively refining an initial binary mask based on pixel clustering, thereby avoiding the reliance on ground truth data which is required for the training of conventional machine learning (ML) based approaches.

In addition, the method of the present invention may improve the accuracy of lesion segmentation compared to binary segmentation techniques alone.

Generating the final segmentation mask may comprise determining whether a pixel cluster should be excluded from the first segmentation mask in order to generate the final segmentation mask. This may be advantageous to refine the first binary segmentation mask.

Determining whether the pixel cluster should form a part of a final segmentation mask may be based on the relative position of each pixel cluster.

The method may further comprise obtaining a bounding box for the at least one image, wherein the bounding box defines a perimeter of an area of the at least one image which comprises the lesion; and

wherein determining, for each pixel cluster, whether the pixel cluster should form a part of the final segmentation mask comprises:
determining the centroid of the pixel cluster;
determining the minimum distance from the determined centroid to any border or boundary of the bounding box;
comparing the minimum distance to a predetermined threshold; and
determining whether the pixel cluster should form a part of the final segmentation mask based on the comparison of the minimum distance to the predetermined threshold.

Whilst the above is disclosed with reference to a minimum distance to any border of the bounding box, the skilled person will understand that the same method may be applied with reference to any other boundary, including but not limited to the boundary or border of the binary segmentation mask, or the convex hull of the binary segmentation mask.

Determining, for each pixel cluster, whether the pixel cluster should form a part of the final segmentation mask may, additionally or alternatively, comprise determining whether the pixel cluster should be classified as noise; and then determining whether the pixel cluster should form a part of the final segmentation mask based on whether the pixel cluster is classified as noise. For example, pixel clusters which are classified as noise may be excluded from the final segmentation mask.

Alternatively or in addition, the method may comprise determining, for each pixel cluster, whether to classify the pixel cluster as noise, and in the event that the pixel cluster is classified as noise, assigning a portion of pixels from the first pixel cluster to a new second pixel cluster, wherein the portion of pixels assigned to a new second pixel cluster are a portion of pixels from the first pixel cluster closest to the centre of the image. The method may then reassess whether to classify the second pixel cluster as noise.

The method may further comprise applying a score to each pixel cluster, wherein the score corresponds to the likelihood of the pixel cluster comprising lesional tissue; and determining whether the pixel cluster should form a part of the final segmentation mask based at least in part on the score of the pixel cluster.

For example, the method may comprise:
applying a score to each pixel cluster, wherein the score corresponds to the likelihood of the pixel cluster comprising lesional tissue;
sorting the plurality of pixel clusters into a sequence based on the score of each pixel cluster; and
generating the final segmentation mask by iteratively excluding at least one pixel cluster from the first segmentation mask based on the sequence of pixel clusters, to generate the final segmentation mask, until at least one rule is satisfied.

Satisfying the at least one rule may comprise a confidence score for the final segmentation mask exceeding a minimum threshold, or alternatively a penalty score for the final segmentation mask falling below a threshold to an acceptable level. Optionally, the confidence score or penalty score may be based on the scores of each pixel cluster within the current iteration of the segmentation mask.

Each score may be at least in part based on the position of each pixel cluster within the image.

Grouping the first set of pixels into a plurality of pixel clusters may comprise, but is not limited to, applying a data clustering algorithm, such as density-based spatial clustering of applications with noise, DBSCAN.

Generating the final segmentation mask for the image may, additionally or instead, be based on satisfying at least one rule or a set of rules.

The at least one rule, or at least one rule of the set of rules, may comprise a boundary constraint configured to ensure that the final segmentation mask is configured such that the final area defined by the final segmentation mask does not contact or intersect the perimeter of the bounding box. This may be advantageous to ensure that the reference bounding box is not oversaturated.

The at least one rule, or at least one rule of the set of rules, may comprise a centroid proximity constraint configured to ensure that the centroid of a lesion segmented from the final mask is maintained within a defined distance relative to the centroid of the lesion segmented from at least one of the plurality of segmentation masks. This may be advantageous to improve accuracy of the final mask generation to ensure that the centroid of the lesion segmented by the final generated mask does not significantly vary from the at least one of the plurality of segmentation masks.

The at least one rule, or at least one rule of the set of rules, may comprise an area continuity constraint configured to ensure that the area of a lesion segmented from a second image is less than or equal to the area of the lesion segmented from a first image, wherein the first image and the second image are adjacent cross-sectional slices from the scan, and wherein the first image is obtained closer to the centroid of the lesion and/or the reference slice than the second image. For example, the area continuity constraint configured may be configured to minimise area penalties, wherein area penalties are incurred for segmentation masks wherein the area of a lesion segmented from a second image is greater than the area of the lesion segmented from a first image. This may be advantageous as lesions are generally largest at the centre and have a reducing cross-sectional area, thus applying such an area continuity constraint may improve accuracy and reliability of the segmentation.

The at least one rule, or at least one rule of the set of rules, may comprise a shape integrity constraint configured to ensure that irregular boundaries representing outgrowths in shape of a lesion segmented from an image are minimised, such that the shape integrity constraint is configured to promote smooth and regular lesion shapes segmented from an image.

The method may further comprise determining the area of the lesion based on the segmented area of the at least one image. This may be determined by calculating the area of the final segmentation mask identifying the lesion.

In embodiments comprising obtaining a plurality of images, each image corresponding to a cross-sectional slice from the scan, the method may then further comprise determining the volume of the lesion based on the segmented area of the lesion in each of the plurality of segmented images. This may comprise summing the areas of the final segmentation mask for each image, optionally accounting for slice thickness (i.e. the distance between consecutive cross-sectional images). Alternatively, the method may further comprise generating a three-dimensional model of the lesion based on the plurality of segmented images, and determining the volume of the lesion based on the three-dimensional model of the lesion.

In some examples, the method may further comprise applying a weighting to each pixel within the segmented area of the at least one segmented image, wherein the weighting is based on the relative intensity of each pixel within the segmented area, and determining an indication of mass of the lesion based on the weightings applied to each pixel within the segmented area of the at least one segmented image. This may be advantageous to provide an indication of lesion density. Lesion density can be an important measurement parameter, in particular many targeted drugs may impact tumour density. As such, quantifying and measuring tumour density can provide important insight into the efficacy of such drugs during treatment as in some instances tumour volume may be relatively unaffected despite changes in tumour density within the volume due to the effect of these drugs.

Additionally, applying a weighting to each pixel and determining an indication of mass may reduce some of the oversegmentation errors, especially in non-solid areas which may be assigned a lower weighting. In essence, instead of viewing a segmented area with uniform and unitary weight (“volume”), the method may measure “effective volume” (a surrogate for mass), which weighs each pixel based on its relative intensity compared to the maximum intensity within that tumour.

In some examples, the obtained at least one image, or set of images, is based on a scan of at least a part of a patient's lung. For examples, obtaining at least one image may comprise obtaining a plurality of images based on a scan of at least a part of a patient's lung, each image corresponding to a cross-sectional slice from the scan, such as a CT or MRI scan. The method may further comprise repeating steps (b) to (e) for each of the plurality of images.

Alternatively, the computer-implemented method provided for determining the area of a lesion from a scan of at least a part of a patient may comprise:
(a) obtaining a plurality of images based on a scan of a part of a patient's anatomy, each image corresponding to a cross-sectional slice from the scan;
(b) for each image, applying a first binary segmentation technique to the image to generate a first binary mask, the first binary mask delineating a first set of pixels within the image, the first set of pixels corresponding to a first area within the image comprising a lesion;
(c) for each image, grouping the first set of pixels into a plurality of pixel clusters, based on the relative proximity of each pixel within the first set of pixels;
(d) for each image, generating a final segmentation mask, based on determining for each pixel cluster whether the pixel cluster should form a part of the final segmentation mask for that image; and
(e) for each image, segmenting the at least one image using the final segmentation mask to define the area of a lesion within the at least one image.

The skilled person will understand that all features disclosed with regard to the preceding aspect of the invention may also apply to this method.

For example, the method may further comprise determining the volume of the lesion based on the segmented area of the lesion in each of the plurality of segmented images and/or the plurality of final segmentation masks. This may comprise summing the areas of the final segmentation mask for each image, optionally accounting for slice thickness (i.e. the distance between consecutive cross-sectional images). Alternatively, the method may further comprise generating a three-dimensional model of the lesion based on the plurality of segmented images, and determining the volume of the lesion based on the three-dimensional model of the lesion.

In some examples, the method may further comprise applying a weighting to each pixel within the segmented area of the at least one segmented image, wherein the weighting is based on the relative intensity of each pixel within the segmented area, and determining an indication of mass of the lesion based on the weightings applied to each pixel within the segmented area of the at least one segmented image. This may be advantageous to provide an indication of lesion density. Additionally, applying a weighting to each pixel and determining an indication of mass may reduce some of the oversegmentation errors, especially in non-solid areas which may be assigned a lower weighting.

In another aspect, there is provided a computer-implemented method for determining an indication of mass of a lesion from a scan of at least a part of a patient. The method comprises obtaining at least one segmented image based on a scan of at least a part of a patient's anatomy, the at least one segmented image defining a segmented area within the image, the segmented area comprising a lesion. The method then comprises applying a weighting to each pixel within the segmented area based on the relative intensity of each pixel within the segmented area. The method then determines an indication of mass of the lesion based on the weightings applied to each pixel within the segmented area.

This may be advantageous to provide an indication of mass of a lesion. Lesion mass can be an important measurement parameter, in particular many targeted drugs may impact tumour mass or density, whereas tumour volume may be relatively unaffected. As such, quantifying and measuring an indication of tumour mass can provide important insight into the efficacy of such drugs during treatment.

Additionally, applying a weighting to each pixel and determining an indication of mass may reduce some of the oversegmentation errors in segmented images, especially in non-solid areas which may be assigned a lower weighting. In essence, instead of viewing a segmented area with uniform and unitary weight (“volume”), the method may determine an “effective volume” (a surrogate for mass), which weighs each pixel based on its relative intensity compared to the maximum intensity within that tumour or lesion.

Applying a weighting to each pixel within the segmented area of the at least one segmented image may comprise identifying at least one pixel having the highest intensity within the segmented area, and applying the weighting to each pixel within the segmented area, based on the intensity of each pixel normalised relative to the intensity of the at least one pixel having the highest intensity.

For example, identifying the at least one pixel having the highest intensity within the segmented area may comprise identifying a first plurality of pixels, the first plurality of pixels corresponding to a predetermined portion of pixels within the segmented area having the highest intensity, and determining the average intensity of the first plurality of pixels. Applying the weighting to each pixel within the segmented area may then be based on the intensity of each pixel normalised relative to the determined average intensity of the first plurality of pixels. This may be advantageous to reduce errors in intensity resulting from anomalous noise.

This method may be applied to a set of segmented images, for example wherein the set of segmented images are based on a scan.

The method may be configured to self-normalise, for example wherein the weighting applied to each pixel within the segmented area of an image is based on the relative intensity of that pixel within the segmented area of the set of images as a whole. For example, the method may apply weighting to each pixel relative to the maximum intensity value of the segmented lesion from the set of images as a whole.

Alternatively, the method may be configured to apply a weighting to each pixel within the segmented area of an image based on the relative intensity of that pixel within its specific image. This may be advantageous to ensure the measure remains robust even in the presence of contrast that might only appear in a subsequent scan and not in previous ones.

In some examples, the obtained at least one segmented image is based on a scan of at least a part of a patient's lung, for example from a CT scan.

The skilled person will understand that this method may be incorporated with the methods of the previous aspects disclosed above. For example, wherein the at least one segmented image is obtained according to any of the preceding methods disclosed herein.

In another aspect of the invention, there is provided a computer readable non-transitory storage medium comprising a program for a computer configured to cause a processor to perform the method of any preceding aspects of the invention.

### DRAWINGS

Embodiments of the disclosure will now be described, by way of example only, with reference to the accompanying drawings, in which:

FIG. 1A shows a flow diagram for an example method of the present invention for determining the area of a lesion from a patient scan.

FIG. 1B shows a flow diagram for an alternative example method of the present invention for determining the area of a lesion from a patient scan.

FIG. 2 shows a schematic illustrating image segmentation, for example in accordance with the methods of FIGS. 1A and 1B.

FIG. 3 shows a flow diagram for an alternative example method of the present invention for determining the area of a lesion from a patient scan.

FIG. 4 shows a schematic illustrating image segmentation, for example in accordance with the method of FIG. 3.

FIG. 5 shows a flow diagram for an alternative example method of the present invention for determining the area of a lesion from a patient scan.

FIGS. 6A to 6E shows a sequence of images illustrating image segmentation, for example in accordance with the method of FIG. 5.

### SPECIFIC DESCRIPTION

Embodiments of the claims relate to computer-implemented methods for determining the area of a lesion, and/or an indication of mass of the lesion, from a scan, in particular from a scan wherein each image from the scan corresponds to a cross-sectional slice of a patient.

### 1) Lesion Area Determination Based on Image Segmentation Through Internal Optimisation of a Combination of Computer Vision Techniques

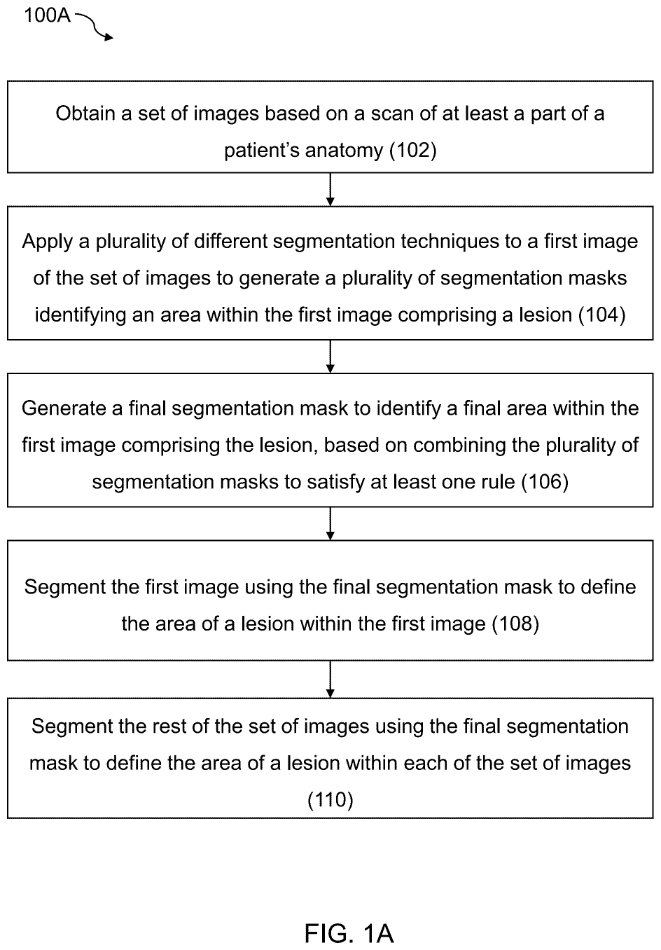

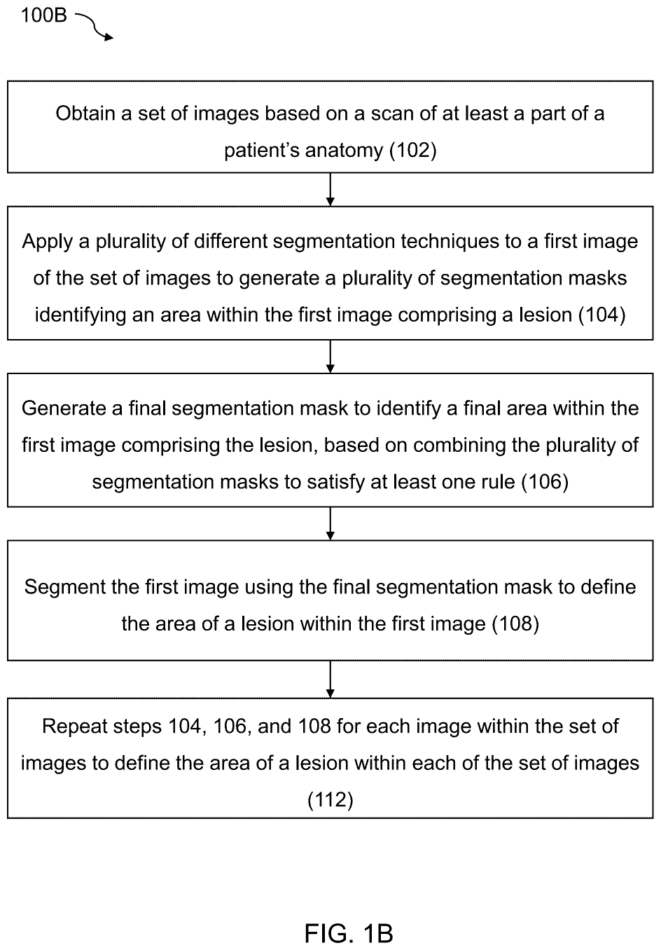

A first embodiment of the invention relates to a computer-implemented method for determining the area of a lesion from a scan, based on image segmentation through internal optimisation of a combination of computer vision algorithm-based initial segmentation masks. An example method 100A is shown by way of a flow diagram in FIG. 1A.

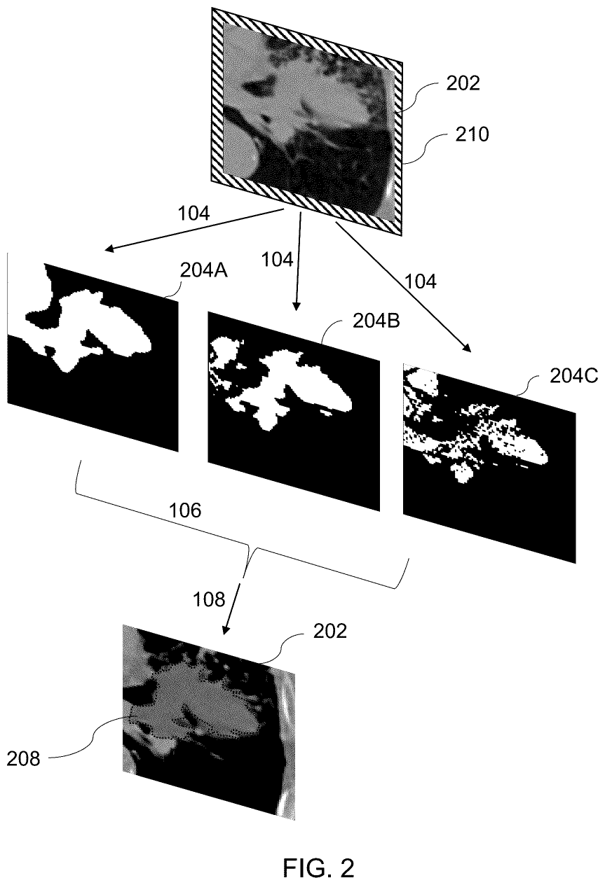

The method 100A comprises obtaining a first image of at least a part of a patient's anatomy, based on a scan. An example first image 202 is shown in FIG. 2. Preferably, the first image 202 is part of an obtained set of images based on the scan of the patient. In the example discussed herein, the method comprises obtaining a set of images (102) based on a CT scan of a patient, for example wherein the CT scan includes at least a part of the patient's lungs.

The first image 202 may be the reference slice of a scan.

A bounding box (BBox) 210 is obtained for the first image 202. The bounding box 210 defines a perimeter of an area of the first image 202 which completely contains the lesion. The bounding box 210 may be obtained from input by a radiologist, or via automatic bounding box annotation, for example based on object detection methods.

The method 100A then comprises applying a plurality of different segmentation techniques to the first image 202 to generate a plurality of segmentation masks (104). In particular, the plurality of segmentation techniques may be applied to the part of the first image 202 contained by the bounding box 210.

Three segmentation masks 204A, 204B, and 204C are illustrated by way of example in FIG. 2, applied to the first image 202. Use of three segmentation masks has been found to be particularly advantageous to generate sufficiently accurate results, without creating an excessive computational burden which may otherwise be caused by applying an increasing number of initial segmentation techniques to create an increasing number of masks.

In this example, the first segmentation mask 204A may be a K-means mask, generated by K-means segmentation. This mask 204A is configured to delineate lung tissues from parenchyma, thus setting a foundational boundary within which the lesion invariably resides.

The second segmentation mask 204B may be an initial Chan-Vese mask, generated by Chan-Vese segmentation, or other level set method.

The third segmentation mask 204C may be an iterative K-means mask, generated after regional equalization. A secondary Kmeans mask, generated post-regional equalization, may be configured to introduce a finer granularity to the segmentation process. This mask may be more intricate, allowing for a sharper distinction between various tissue types.

The skilled person will understand that, while we have described specific segmentation techniques and masks, initial segmentation masks drawn from other computer vision algorithms, like Grab Cut, or alternative segmentation techniques, such as Level set, can either replace or be implemented alongside the segmentation techniques described above.

The method 100A then generates a final segmentation mask (106) to identify a final area within the first image 202 comprising the lesion, based on combining the plurality of segmentation masks 204A, 204B, and 204C to satisfy at least one rule. In particular, generating the final segmentation mask for the image may comprise iteratively refining the final segmentation mask to optimise the set of rules or constraints. This may be implemented using genetic optimisation algorithms.

In this example, generating the final segmentation mask (106) is based on combining the plurality of segmentation masks 204A, 204B, and 204C using a genetic optimisation algorithm to satisfy a set of rules or constraints. These are broadly classified into static and dynamic constraints.

In this example, the set of rules of constraints may include:
(i) a boundary constraint: configured to ensure that the final segmentation doesn't touch the image boundaries (for example, the boundary of the bounding box 210) to in turn ensure that the reference bounding box (BBox) isn't being oversaturated;
(ii) a centroid proximity constraint: configured to ensure the relative positions or distances between centroids of the initial segmentation masks, 204A, 204B, and 204C, are maintained within defined thresholds;
(iii) a DICE score constraint: configured to ensure that the DICE score between at least one of the initial masks, such as the Chan-Vese mask 204B, and the final segmentation falls within pre-established boundaries;
(iv) containment within an initial mask, such as the K-means mask: given the first K-means mask 204A's function of discerning tissues from parenchyma, the containment constraint is configured to ensure that the final segmentation solution is always confined within it. However, the skilled person will understand the containment within an initial segmentation constraint may be implemented with respect to any other initial segmentation mask, not being limited to the first K-means mask 204A; and
(v) area continuity constraint: when applied to a set of scan images, the area continuity constraint is configured to ensure that the segmented area in a current slice isn't larger than the previous slice in order to maintain a coherent progression from the first reference “slice” or image. For the first image or reference “slice” 202, the previous slice segmentation area may be determined to be the area of the bounding box 210.

The skilled person will understand that the above specific constraints and internal consistency criteria are not intended to be limiting or exhaustive. Other constraints can be considered, either in conjunction with the constraints discussed above, or as replacements.

Post-optimisation, a second Adaptive Chan-Vese Mask may be generated. This is derived by re-computing the Chan-Vese segmentation, but within the bounds of the final mask produced by the genetic optimisation. The DICE score between this adaptive mask and the final generated mask may then be obtained which acts as an internal consistency measure, ascertaining the robustness of the generated final segmented output. This DICE score may be compared to a predetermined range to determine whether the consistency between the adaptive mask and the final generated mask is acceptable. This internal consistency criterion harmoniously complements the other set of constraints. Together, they forge a symbiotic relationship that, when satisfied concurrently during the optimisation process, assures the evolution towards an optimal segmentation mask.

The skilled person will understand that whilst Chan-Vese segmentation is disclosed, any other level set method may be used.

Once a final segmentation mask that satisfies the set of rules has been generated, the method 100A proceeds to segment the first image 202 using the final mask to define the area of the lesion within the first image (108). As shown in FIG. 2, the final segmentation mask 208 is applied to the first image 202 to define and segment the lesion area defined by the mask 208. The segmented area 208 may then be used to determine the area of the lesion within the first image 202.

Applying the same segmentation techniques and logic used to combine the initial masks 204A to 204C to arrive at the final segmentation mask 208, the method 100A may then segment the rest of the set of images to define the area of a lesion within each of the set of images (110).

The method 100A may proceed from the first image 202 as the reference slice, through adjacent slices or images in the forward direction, and then through adjacent slices or images in the backwards direction, relative to the reference slice, or vice versa. This allows the area continuity constraint to be correctly applied to ensure that the segmented area in a current slice is not larger than the previous slice in order to maintain a coherent progression in area from the first reference slice to the outer edges of the lesion.

The bounding box 210 may be repositioned and/or resized the bounding box for each image or “slice” to ensure the lesion retains a substantially central positioning within the bounding box 210. For example, as the method progresses through the slices, a sizing constraint may be employed to ensure that the bounding box 210 and/or segmented area for a given slice typically remains smaller or at least equivalent to the previous slice's area. Notably, if there's an expansion in the bounding box 210 and/or segmented area across consecutive slices, it may indicate difficulties in differentiating lesion tissue from neighbouring tissue structures. This constraint may be advantageous to halt further segmentation in this instance to avoid discrepancies in the final area and/or volume estimations.

The segmented area of each image may then be used to determine the area of the lesion within each image. Alternatively, or in addition, the segmented areas of each image may be combined to determine the total volume of the lesion, based on the set of cross-sectional images. For example, the method may be configured to generate a 3D model of the lesion based on applying 3D morphological operations across the final segmented area across all slices, accounting for slice thickness within the set of images.

Alternatively, as shown by FIG. 1B, the steps of applying a plurality of different segmentation techniques (104), generating a final segmentation mask (106), and image segmentation using the generated final mask (108) are repeated for each image within the set of images in order to define the area of the lesion within each image. As such, combining the initial segmentation masks, for example using a genetic algorithm, is restarted independently for each image (i.e., the logic used to combine the initial masks from the previous image is not reused). This may take longer and require greater computational overhead than method 100A, however repeating these steps for each image within the set may result in a more accurate segmentation of the lesion. As above, the segmented area of each image may then be used to determine the area of the lesion within each image. Alternatively, or in addition, the segmented areas of each image may be combined to determine the total volume of the lesion, based on the set of cross-sectional images. For example, the method may be configured to generate a 3D model of the lesion based on applying 3D morphological operations across the final segmented area across all slices, accounting for slice thickness within the set of images.

Unlike prevalent deep learning models that mimic the brain's fluid processing, the present method adheres to the set of constraints and internal benchmarks, prioritising logical operations, general morphological operations, and dynamic objects. This approach differs significantly from existing deep learning models used, and critics may raise concerns over the computational overhead introduced by the integration of multiple masks and the genetic algorithms' utilisation. However, the present method's adaptability and ability to identify and segment lesions for determinations of lesion area and volume, without reliance on ground truths should not be understanded. In addition, it is noted that the present method may additionally serve as a ground truth generator to facilitate the training of subsequent deep learning models, for example wherein deep learning models may be trained based on the segmentations generated by the present method.

It is also noted that the inclusion of additional initial segmentation masks could further refine the segmentation process, enhancing both specificity and generalizability.

### 2) Lesion Area Determination Based on Image Segmentation Through Adaptive Growing Control of Segmentation Masks

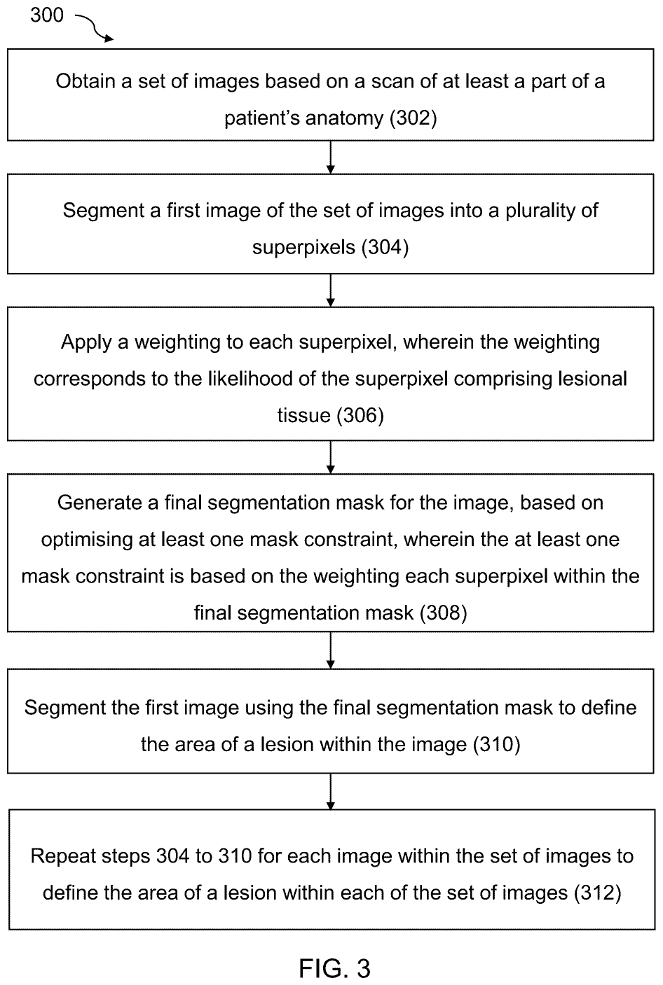

A second embodiment of the invention relates to a computer-implemented method for determining the area of a lesion from a scan, based on image segmentation through adaptive growth control of segmentation masks. An example method 300 is shown by way of a flow diagram in FIG. 3.

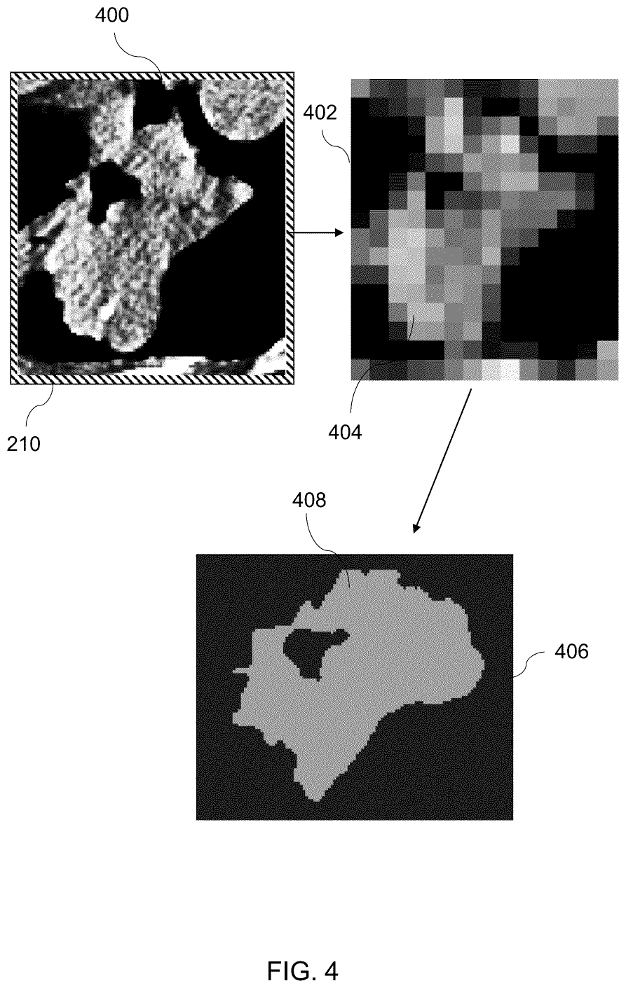

The method 300 comprises obtaining a set of images of at least a part of a patient's anatomy, based on a scan (302). A first image from the set of images is selected for initial processing. An example first image 400 is shown in FIG. 4. In the example discussed herein, the method comprises obtaining a set of images based on a CT scan of a patient, for example wherein the CT scan includes at least a part of the patient's lungs. Each image within the set of images may be referred to as a “slice”, corresponding to a cross-sectional slice of the part of the patient's anatomy from the scan.

The first image 400 may be the reference slice of a scan.

A bounding box (BBox) 210 is obtained for the first image 400. The bounding box 210 defines a perimeter of an area of the first image 400 which completely contains the lesion. The bounding box 210 may be obtained from input by a radiologist, or via automatic bounding box annotation, for example based on object detection methods. Only the region of the first image 400 within the bounding box 210 is shown in FIG. 4.

The method 300 then comprises segmenting the region of the first image 400 within the bounding box 210 into a plurality of superpixels (304). Image 402 illustrates the first image 400 segmented into a plurality of superpixels 404. Preferably, the method 300 comprises segmenting the first image 400 using a Simple Linear Iterative Clustering (SLIC) algorithm. Parameters for the segmentation, such as the SLIC algorithm, may be iteratively adjusted to ensure a consistent number of superpixels 404 within the bounding box 210.

Each superpixel 404 (also known as a SLIC segment) is scored (306). In this example, each superpixel 404 is scored based on its proximity to the centre of the bounding box 210. Superpixels 404 touching the bounding box edge may be scored appropriately to ensure their exclusion in subsequent processing steps. The superpixel scores are normalized thereafter.

The skilled person will understand that the scoring may, instead or in addition, be based on other properties of the superpixel, such as intensity and texture properties. However, this can sometimes lead to inconsistent results due to intra-lesion variability within the same slice or image.

The method 300 then comprises generating a final segmentation mask, such as final segmentation mask 406, for the image, based on optimising at least one mask constraint (308). The at least one mask constraint is based on the weighting of each superpixel within the final segmentation mask, for example wherein optimising the mask constraint may comprise minimising a penalty score based on the weighting each superpixel, and/or maximising a confidence score based on the weighting each superpixel.

In this example, the final segmentation mask is generated by iteratively adding superpixels 404 to the mask starting from the highest scored (e.g. most central) superpixels 404, and prioritising contiguous superpixels. In addition, in this example, growth regulation is optimised using a dual-method regularisation method. The dual-method regularisation approach may ensure a balanced representation of lesion expansion and contraction within the final segmentation mask.

The first aspect of the dual-method regularisation approach is expansion-based regularisation. This controls the expansion of the final mask to include more superpixels, whilst ensuring the final mask remains within defined boundaries without excessive deviations.

For example, the equation:

$${Δ}_{-} ( hull ) > {A}_{-} ( previous ) \times γ \times ( 1 - {A}_{-} ( temp ) / {A}_{-} ( previous ) )$$

serves as a regularization constraint, wherein:
Δ_(hull) represents the change in the convex hull area of the final mask after having added a segment. This change indicates how much the final mask has grown.
A_(previous) represents the previous slice segmentation area, providing a reference for the permissible growth. It acts as an upper bound to the segment growth, ensuring the lesion doesn't grow beyond the dimensions of the previous area. For the first image or “slice” 404 in a set of images, the previous slice segmentation area may be determined to be the area of the bounding box 210.
γ represents a scaling factor that modulates the allowable change. It may dictate how aggressive or conservative the growth can be.
(1−A_(temp)/A_(previous)) represents a normalization factor. As the current temporary area A_(temp) approaches the area of the previous slice segmentation, this factor decreases, thereby ensuring growth becomes more conservative as the size of the mask nears its permissible bounds. This ensures that as the generated mask grows closer to its previous area, its growth rate gets increasingly constrained.

In essence, this equation ensures that segment growth is controlled and kept in check, preventing unregulated expansion, and ensuring the lesion remains accurately represented by the final segmentation mask. It incorporates both the previous segmentation of the lesion from preceding slices and the current growth, thus offering a balanced and robust growth regularisation. Accounting for previous segmentations of the lesion within the growth regularisation ensures generation of the mask for the current slice is informed and doesn't stray too far from previously established lesion dimensions, factoring in safety margins which may be determined by slice thickness.

Based on this approach, rapid expansions in size that attempt to grow too quickly beyond the previous known boundaries of the segmented lesion are penalised. Irregular expansions are also penalised as the growth mechanism tends to promote smoother and more regular growth. Shapes that exhibit sudden or irregular outgrowths may be constrained. In addition, over expansions are also penalised as if the temporary area gets very close to the previously known area of the lesion in a previous slice, further expansion within the iterative generation of the final mask for that slice becomes heavily regularised, essentially penalizing forms that are trying to outgrow their known dimensions.

The second aspect of the dual-method regularisation approach is contraction-based regularisation. This methodically removes superpixels during generation of the final mask, particularly those with lower confidence or more external positioning.

The process begins by adjusting the previous lesion area, or area of the bounding box 210, using a regularisation factor, reg_factor, for example using the equation:

$$previous\_area = previous\_area - ( previous\_area \times reg\_factor )$$

For the first image or “slice” 404, the previous slice segmentation area, previous_area, may be determined to be the area of the bounding box.

Under contraction-based regularisation superpixels are iteratively removed during generation of the final mask, beginning with removal of the superpixels having the lowest score or confidence. The contraction-based regularisation process may stop when the area of the mask post-removal drops below the adjusted previous_area.

As such, expansion and contraction methods are synergistically applied over iterations with adjustable parameters, γ and reg_factor. Post-regularisation, expansion- and contraction-based masks are merged, yielding potential lesion representations. Each representation may be further evaluated by a penalty function targeting irregular forms or those not adhering to criteria in order to determine the final mask for that slice or image.

The optimal lesion representation minimizes the penalty, providing the most plausible and accurate depiction given the constraints and criteria. This adaptive regularisation approach addresses both under-segmentation and over-segmentation effectively to accurately generate the final mask.

The optimal lesion representation 408 is then used as the final mask 406 to segment the first image 400, as shown in FIG. 4 (310).

The steps of segmentation into superpixels (304), applying weightings to each superpixel (306), generation of a final mask (308), and image segmentation using the final mask (310) are repeated across all images or “slices” from the obtained set of images (312). Generation of a final mask for a current slice is, at least in part, based on the final mask generated for the preceding image or “slice”, in the manner as described above.

For example, the method 300 may proceed from the first image 402 as the reference slice, through adjacent slices or images in the forward direction, and then through adjacent slices or images in the backwards direction, relative to the reference slice, or vice versa.

Subsequent to the generation of the final mask, various post-processing steps, including filtering and morphological operations may be performed on individual slices. In addition, or instead, post-processing steps including 3D morphological or filtering operations may be employed across the final masks across all slices, for example to correct any isolated over-segmentations that may have occurred in select slices.

The segmented area of each image may then be used to determine the area of the lesion within that image. Alternatively, or in addition, the collective segmented areas from the set of images may be combined to determine the total volume of the lesion, based on the set of cross-sectional images and accounting for slice thickness within the set of images.

The present method therefore advantageously presents an alternative method to identify and segment lesions from patient scans for determinations of lesion area and volume, without reliance on ground truths.

### 3) Lesion Area Determination Based on Image Segmentation Through Pixel Clustering and Multi-Stage Mask Refinement

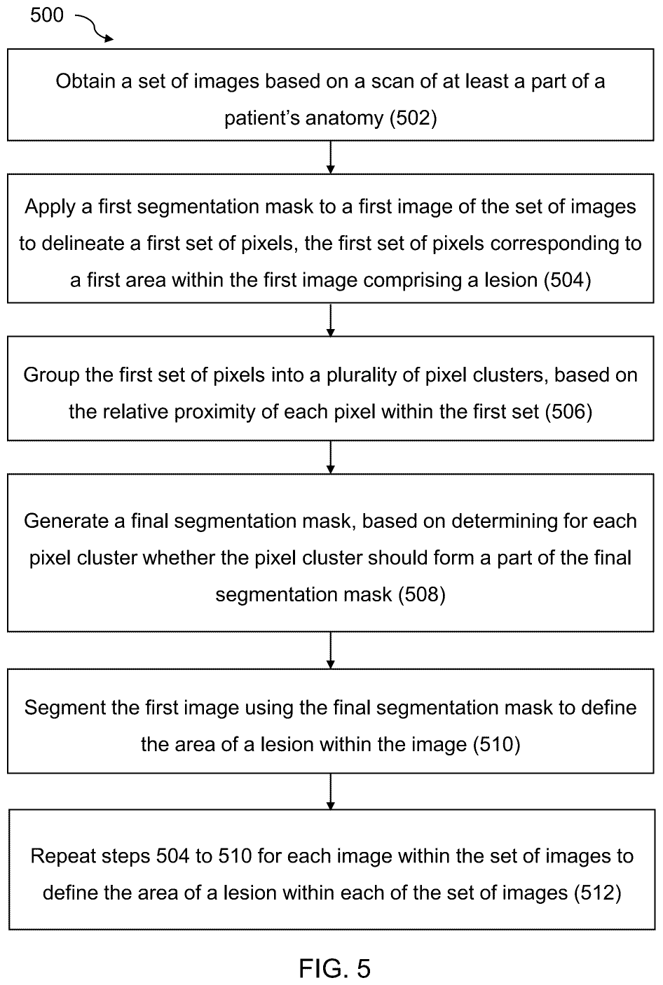

A third embodiment of the invention relates to a computer-implemented method for determining the area of a lesion from a scan, based on image segmentation through multi-stage mask refinement. An example method 500 is shown by way of a flow diagram in FIG. 5.

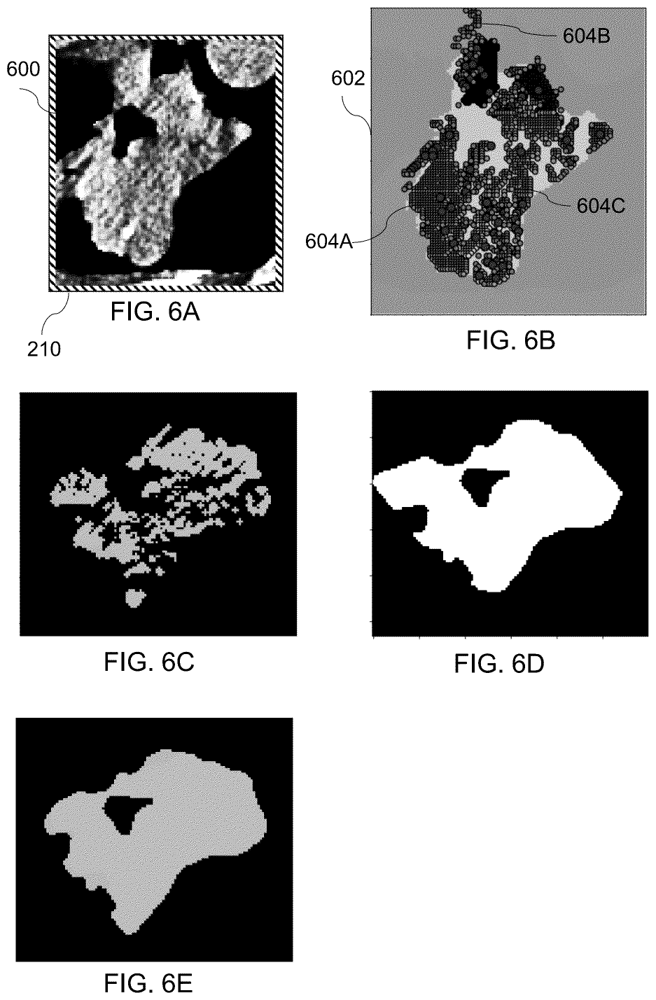

The method 500 first comprises obtaining a set of images of at least a part of a patient's anatomy, based on a scan (502). A first image from the set of images is selected for initial processing. An example first image 600 is shown in FIG. 6. In the example discussed herein, the method comprises obtaining a set of images based on a CT scan of a patient, for example wherein the CT scan includes at least a part of the patient's lungs. Each image within the set of images may be referred to as a “slice”, corresponding to a cross-sectional slice of the part of the patient's anatomy from the scan. The first image 600 may correspond to the reference slice of the scan.

A bounding box associated with the first image 600 is also obtained.

The method 500 then comprises applying a first segmentation technique to the first image 600, in order to generate an initial segmentation mask (504). In particular, the first segmentation technique is applied to the portion of the first image 600 within the bounding box 210. The initial segmentation mask is configured to identify a first area of the first image 600 which comprises the lesion. The initial segmentation mask may be a binary segmentation mask, or otherwise may undergo subsequent binarization in order to define the first area by a first set of pixels from the first image 600.

The binary initial segmentation mask is then processed to refine the mask by excluding regions that might result from artifacts or inaccuracies near the boundaries or borders of the bounding box. This is performed by grouping the first set of pixels into a plurality of pixel clusters, based on the relative proximity of each pixel within the first set (506). For example, the coordinates of all the active pixels (value=1) in the mask are extracted, and the active pixel coordinates may be grouped, for example by a clustering algorithm, such as but not limited to DBSCAN (Density-Based Spatial Clustering of Applications with Noise) clustering algorithm. The pixels that are close to each other may be grouped into individual regions or clusters, such that clustering may be based on the proximity of pixels to other neighbouring pixels. FIG. 6B illustrates an example image 602 comprising a plurality of pixel clusters, including but not limited to pixel clusters 604A, 604B, and 604C, which are identified purely for illustration.

Labels are assigned to each region or cluster identified by the grouping step.

For each identified region (or cluster), its centroid is then computed. The minimum distance from the centroid to any of the borders (top, bottom, left, and right) of the bounding box 210 is then calculated.

If this minimum distance is less than a predefined threshold, the entire region is removed from the mask.

In addition, any outlier regions may be labelled as noise. If a region is identified as noise, the entire region may be removed from the mask. Alternatively, pixels within the cluster which are closer to the image centre may be assigned to a new cluster, while the outer pixels ones retain their noise classification are subsequently removed from the mask.

The method then returns a modified segmentation mask, where regions that were too close to its borders, or were classified as noise, have been eliminated. This may be advantageous as regions close to the border of an image or mask can often result from various artifacts, boundaries, or imaging inconsistencies. By removing such regions, this method aids in yielding a cleaner and more accurate representation of the lesion, reducing the chances of misinterpretation or errors in subsequent analyses.

The modified segmentation mask may be subject to further refinement. In particular, the modified segmentation mask may be processed to selectively remove regions or clusters from the input mask until the area of the mask, post computation of its convex hull, is under a specified value. The specified value may be determined based on the area of the preceding slice, for example such that the area must be equal to or less than the area of the slice closer to the reference slice.

Every cluster is scored based on its distance from the centre of bounding box for the first image 600. Clusters are then sequenced based on their score, and are sequentially and iteratively eliminated from this temporary mask based on their sequence. For example, a noisy cluster positioned at the periphery of the mask, far from the first image centre, is prioritised at the beginning of the sequence.

In the example shown in FIG. 6B, pixel cluster 604B is located close to the top border of the mask, far from the centre of the image 602, and is an outlier from the other pixel clusters. As such, purely for illustration, pixel cluster 604B is likely to be prioritised in the sequence to be removed from the mask.

An example of a modified mask post-cluster removal is shown in FIG. 6C. After each cluster's removal, the convex hull of the modified current mask is computed. The convex hull is configured to encompass the lesion regions with the smallest convex shape that entirely covers it, which may be advantageous in eliminating extraneous, non-connected regions or clusters. An example of a modified mask comprising a convex hull, such as a convex hull for the modified mask of FIG. 6C, is shown in FIG. 6D.

Optionally, the convex hull of the modified mask may be intersected with a reference mask to retain only those parts of the hull that align with regions identified in the reference mask. The reference mask may be a reference mask derived from a computer vision segmentation technique, bounded within the bounding box 210. This may be advantageous to ensure the retained regions or clusters align with known zones of the reference mask. If the intersection's area of the current modified mask falls below area of the reference mask, the method may halt the iterative removal process and output the resulting final mask.

The resulting final mask may then be used to segment the first image 600 to define the area of a lesion within the first image 600 (510). An example resulting final mask for the first image 600 is shown in FIG. 6E.

The above method, including steps 504 to 510, may then be repeated for each image within the set of images to define the area of a lesion within each of the set of images (512).

Finally, 3D morphological or filtering operations may also be employed to remove any isolated oversegmentations that may have occurred in any images from the set of images. These are relatively straightforward to eliminate as they tend to appear sporadically across a limited number of “slices” or images, manifesting as notably thin irregularities on the single “slice” or image level.

Inherent to each of the methods disclosed herein, there are termination criteria to indicate the outer edges of lesion. These criteria important to determine the specific “slice” from the set of images where the segmentation process should cease indicating the outer surface of the lesion has been reached, and ensuring enhanced precision in lesion delineation.

The termination criteria may comprise at least one of:
(i) Lesion size: If the segmented lesion attains a size that's below a predetermined threshold, the segmentation method may halt. Alternatively, or in addition, if the segmented lesion attains a size that's below a threshold proportion in comparison to the reference slice area, the segmentation method may halt.
(ii) Assessment of segment area reduction: Throughout the segmentation process, the reduction in segmentation area is monitored as a function of distance from the reference slice. In the event that the segment area does not diminish significantly as we move away from the reference slice, and a substantial fraction of the reference area has already been reached, it may be assumed that the method has most likely segmented the majority of the lesion.
(iii) Segmentation precision considerations: A point can be reached where residual small portions of the lesion coexist with other tissues that become challenging to discern. In such circumstances, pursuing further precise segmentation becomes complex, carrying the risk of introducing errors. However, considering the relative size of these areas and their overall impact on the comprehensive analysis, it may be deemed that minor discrepancies are tolerable, justifying the cessation of segmentation.

These termination criteria ensure that the segmentation is accurate, efficient, and grounded on solid principles, providing reliable outcomes without unnecessarily prolonging the segmentation process.

It will be appreciated from the discussion above that the embodiments shown in the Figures are merely exemplary, and include features which may be generalised, removed, or replaced as described herein and as set out in the claims.

In the context of the present disclosure other examples and variations of the apparatus and methods described herein will be apparent to a person of skill in the art.

The invention is also described by reference to the following clauses:
1. A computer-implemented method for determining the size of a lesion from a scan of at least a part of a patient, the method comprising:
   (a) obtaining at least one image based on a scan of at least a part of a patient's anatomy;
   (b) applying a plurality of different segmentation techniques to the at least one image to generate a plurality of segmentation masks, wherein each segmentation technique is configured to generate a segmentation mask to identify an area within the at least one image comprising a lesion;
   (c) generating a final segmentation mask to identify a final area within the at least one image comprising the lesion, based on combining the plurality of segmentation masks to satisfy at least one rule; and
   (d) segmenting the at least one image using the final segmentation mask to define the area of a lesion within the at least one image.
2. The method of any preceding causes wherein generating the final segmentation mask comprises combining the plurality of segmentation masks to satisfy a set of rules.
3. The method of any preceding clauses wherein generating the final segmentation mask comprises combining the plurality of segmentation masks using a genetic algorithm to satisfy the at least one rule.
4. The method of any preceding clause further comprising obtaining a bounding box for the at least one image, wherein the bounding box defines a perimeter of an area of the at least one image which comprises the lesion, and wherein the plurality of segmentation masks are applied to the area defined by the bounding box.
5. The method of clause 4 wherein the at least one rule comprises a boundary constraint configured to ensure that the final segmentation mask is configured such that the final area defined by the final segmentation mask does not contact or intersect the perimeter of the bounding box.
6. The method of any preceding clause, wherein the at least one rule comprises a centroid proximity constraint configured to ensure that the centroid of a lesion segmented from the final mask is maintained within a defined distance relative to the centroid of the lesion segmented from at least one of the plurality of segmentation masks.
7. The method of any preceding clause, wherein
   obtaining the at least one image comprises obtaining a plurality of images based on a scan of at least a part of a patient's anatomy, each image corresponding to a cross-sectional slice from the scan; and
   repeating steps (b) to (d) for each of the plurality of images.
8. The method of any preceding clause wherein generating the final segmentation mask comprises obtaining a similarity score configured to measure the similarity between the final segmentation mask and at least one of the plurality of segmentation masks; and wherein the at least one rule comprises a similarity score constraint configured to ensure that the obtained similarity score is above a predetermined threshold or within a predetermined range.
9. The method of any preceding clause, wherein the obtained at least one image is based on a scan of at least a part of a patient's lung.
10. The method of clause 9 wherein a first segmentation technique of the plurality of segmentation techniques is configured to generate a first segmentation mask to delineate parenchyma from other lung tissue, for example wherein the first mask is a Kmeans mask;
   and wherein the at least one rule comprises a mask containment constraint, wherein the mask containment constraint is configured to ensure that the final segmentation mask must be confined within the area of the first mask.
11. The method of any preceding clause wherein the plurality of segmentation masks comprises three different segmentation masks.
12. A computer-implemented method for determining the size of a lesion from a scan of at least a part of a patient, the method comprising:
   (a) obtaining at least one image based on a scan of at least a part of a patient's anatomy;
   (b) segmenting the at least one image into a plurality of superpixels;
   (c) applying a weighting to each superpixel, wherein the weighting corresponds to the likelihood of the superpixel comprising lesional tissue;
   (d) generating a final segmentation mask for the image, based on optimising at least one mask constraint, wherein the at least one mask constraint is based on the weighting each superpixel within the final segmentation mask; and
   (e) segmenting the at least one image using the final segmentation mask to define the area of a lesion within the image.
13. The method of clause 12 wherein generating the final segmentation mask for the image, comprises iteratively refining the final segmentation mask to optimise the at least one mask constraint.
14. The method of any of clauses 12 to 13 wherein applying the weighting to each superpixel is based on the relative position of each superpixel.
15. The method of any of clauses 12 to 14 further comprising obtaining a bounding box for the at least one image, wherein the bounding box defines a perimeter of an area which comprises the lesion within the at least one image; and
   wherein segmenting the at least one image into the plurality of superpixels comprises segmenting the area of the at least one image defined by the bounding box into a plurality of superpixels.
16. The method of clause 15 wherein applying the weighting to each superpixel is based on proximity of the superpixel to the centre of the bounding box, for example wherein superpixels arranged close to the centre of the bounding box are weighted to be more likely to comprise lesional tissue compared to superpixels arranged further from the centre of the bounding box.
17. The method of any of clauses 15 to 16 wherein applying the weighting to each superpixel is based on proximity of the superpixel to the perimeter of the bounding box, for example wherein superpixels arranged close to the perimeter of the bounding box are weighted to be less likely to comprise lesional tissue than superpixels arranged further from the perimeter of the bounding box.
18. The method of any of clauses 12 to 17, wherein obtaining at least one image comprises obtaining a plurality of images based on a scan of at least a part of a patient's lung, each image corresponding to a cross-sectional slice from the scan; and
   repeating steps (b) to (e) for each of the plurality of images.
19. The method of any of clauses 12 to 18 wherein the at least one mask constraint for generating the final segmentation mask for the image is based on at least one of:
   (i) expansion-based mask generation, configured to generate the final segmentation mask to define the area of a lesion based on adding superpixels to the mask based on the weighting of each superpixel within the image; and
   (ii) reduction-based mask generation, configured to generate the final segmentation mask to define the area of a lesion based on removing superpixels from the mask based on the weighting of each superpixel within the image.
20. The method of clause 19 wherein generating the final segmentation mask for the image is based on synergistically applying both expansion-based mask generation and reduction-based mask generation to generate the final segmentation mask.
21. The method any of clauses 12 to 20 wherein segmenting the at least one image into the plurality of superpixels is comprises applying a simple linear iterative clustering, SLIC, algorithm to the at least one image.
22. A computer-implemented method for determining the size of a lesion from a scan of at least a part of a patient, the method comprising:
   obtaining at least one image based on a scan of at least a part of a patient's anatomy;
   applying a first binary segmentation mask to the at least one image to delineate a first set of pixels within the at least one image, the first set of pixels corresponding to a first area within the at least one image comprising a lesion;
   grouping the first set of pixels into a plurality of pixel clusters, based on the relative proximity of each pixel within the first set of pixels;
   generating a final segmentation mask, based on determining for each pixel cluster whether the pixel cluster should form a part of the final segmentation mask; and
   segmenting the at least one image using the final segmentation mask to define the area of a lesion within the at least one image.
23. The method of clause 22 wherein generating the final segmentation mask comprises determining whether a pixel cluster should be excluded from the first segmentation mask in order to generate the final segmentation mask.
24. The method of any of clauses 22 to 23 wherein determining whether the pixel cluster should form a part of a final segmentation mask is based on the relative position of each pixel cluster.
25. The method of any of clauses 22 to 24 further comprising obtaining a bounding box for the at least one image, wherein the bounding box defines a perimeter of an area of the at least one image which comprises the lesion; and
wherein determining, for each pixel cluster, whether the pixel cluster should form a part of the final segmentation mask comprises:
   determining the centroid of the pixel cluster;
   determining the minimum distance from the determined centroid to any border of the bounding box
   comparing the minimum distance to a predetermined threshold; and
   determining whether the pixel cluster should form a part of the final segmentation mask based on the comparison of the minimum distance to the predetermined threshold.
26. The method of any of clauses 22 to 25 wherein determining, for each pixel cluster, whether the pixel cluster should form a part of the final segmentation mask comprises:
   determining whether the pixel cluster should be classified as noise; and
   determining whether the pixel cluster should form a part of the final segmentation mask based on whether the pixel cluster is classified as noise.
27. The method of any of clauses 22 to 26 further comprising:
   determining, for each pixel cluster, whether to classify the pixel cluster as noise;
   in the event that the pixel cluster is classified as noise, assigning a portion of pixels from the first pixel cluster to a new second pixel cluster, wherein the portion of pixels assigned to a new second pixel cluster are a portion of pixels from the first pixel cluster closest to the centre of the image; and
   reassessing whether to classify the second pixel cluster as noise.
28. The method of any of clauses 22 to 27 further comprising:
   applying a score to each pixel cluster, wherein the score corresponds to the likelihood of the pixel cluster comprising lesional tissue; and
   determining whether the pixel cluster should form a part of the final segmentation mask based at least in part on the score of the pixel cluster.
29. The method of any of clauses 22 to 28 further comprising:
   applying a score to each pixel cluster, wherein the score corresponds to the likelihood of the pixel cluster comprising lesional tissue;
   sorting the plurality of pixel clusters into a sequence based on the score of each pixel cluster; and
wherein generating the final segmentation mask comprises:
   iteratively excluding at least one pixel cluster from the first segmentation mask based on the sequence of pixel clusters, to generate the final segmentation mask, until at least one rule is satisfied.
30. The method of any of clauses 28 to 29 wherein each score is at least in part based on the position of each pixel cluster within the image.
31. The method of any of clauses 22 to 30 wherein grouping the first set of pixels into a plurality of pixel clusters comprises applying a data clustering algorithm, such as density-based spatial clustering of applications with noise, DBSCAN.
32. The method of any of clauses 12 to 31 wherein generating the final segmentation mask for the image is further based on satisfying at least one rule.
33. The method of any of clauses 1 to 11, or claim 32, wherein the at least one rule comprises a centroid proximity constraint configured to ensure that the centroid of a lesion segmented from a second image is maintained within a defined distance relative to the centroid of the lesion segmented from a first image, wherein the first image and the second image are adjacent cross-sectional slices from the scan.
34. The method of any of clauses 1 to 11, or clauses 32 to 33, wherein the at least one rule comprises an area continuity constraint configured to minimise area penalties, wherein area penalties are incurred for segmentation masks wherein the area of a lesion segmented from a second image is greater than the area of the lesion segmented from a first image, wherein the first image and the second image are adjacent cross-sectional slices from the scan, and wherein the first image is obtained closer to the centroid of the lesion than the second image.
35. The method of any of clauses 1 to 11, or clauses 32 to 34, wherein the at least one rule comprises a shape integrity constraint configured to ensure that irregular boundaries representing outgrowths in shape of a lesion segmented from an image are minimised, such that the shape integrity constraint is configured to promote smooth and regular lesion shapes segmented from an image.
36. The method of any preceding clause further comprising determining the area of the lesion based on the segmented area of the at least one image.
37. The method of any preceding clause wherein obtaining the at least one image based on a scan of at least a part of a patient's lung comprises obtaining a plurality of images, each image corresponding to a cross-sectional slice from the scan; and the method further comprising determining the volume of the lesion based on the segmented area of the lesion in each of the plurality of segmented images.
38. The method of clause 37 further comprising generating a three-dimensional model of the lesion based on the plurality of segmented images; and optionally determining the volume of the lesion based on the three-dimensional model of the lesion.
39. The method of any preceding clause, further comprising:
   applying a weighting to each pixel within the segmented area of the at least one segmented image, wherein the weighting is based on the relative intensity of each pixel within the segmented area; and
   determining an indication of mass of the lesion based on the weightings applied to each pixel within the segmented area of the at least one segmented image.
40. The method of any of clauses 12 to 39, wherein the obtained at least one image is based on a scan of at least a part of a patient's lung.
41. A computer-implemented method for determining an indication of mass of a lesion from a scan of at least a part of a patient, the method comprising:
   obtaining at least one segmented image based on a scan of at least a part of a patient's anatomy, the at least one segmented image defining a segmented area within the image, the segmented area comprising a lesion;
   applying a weighting to each pixel within the segmented area, based on the relative intensity of each pixel within the segmented area; and
   determining an indication of mass of the lesion based on the weightings applied to each pixel within the segmented area.
42. The method of clause 41 wherein applying a weighting to each pixel within the segmented area of the at least one segmented image comprises:
   identifying at least one pixel having the highest intensity within the segmented area; and
   applying the weighting to each pixel within the segmented area, based on the intensity of each pixel normalised relative to the intensity of the at least one pixel having the highest intensity.
43. The method of clause 42 wherein identifying the at least one pixel having the highest intensity within the segmented area comprises:
   identifying a first plurality of pixels, the first plurality of pixels corresponding to a predetermined portion of pixels within the segmented area having the highest intensity;
   determining the average intensity of the first plurality of pixels; and
   applying the weighting to each pixel within the segmented area, based on the intensity of each pixel normalised relative to the determined average intensity of the first plurality of pixels.
44. The method of any of clauses 41 to 43, wherein the obtained at least one segmented image is based on a scan of at least a part of a patient's lung.
45. The method of any of clauses 41 to 44 wherein the at least one segmented image is obtained according to the method of any clauses 1 to 38.
46. A computer readable non-transitory storage medium comprising a program for a computer configured to cause a processor to perform the method of any preceding clause.

1. A computer-implemented method for determining the size of a lesion from a scan of at least a part of a patient, the method comprising:
(a) obtaining at least one image based on a scan of at least a part of a patient's anatomy;
(b) applying a plurality of different segmentation techniques to the at least one image to generate a plurality of segmentation masks, wherein each segmentation technique is configured to generate a segmentation mask to identify an area within the at least one image comprising a lesion;
(c) generating a final segmentation mask to identify a final area within the at least one image comprising the lesion, based on combining the plurality of segmentation masks to satisfy at least one rule; and
(d) segmenting the at least one image using the final segmentation mask to define the area of a lesion within the at least one image.

2. The method of claim 1 wherein generating the final segmentation mask comprises combining the plurality of segmentation masks to satisfy a set of rules.

3. The method of claim 1 wherein generating the final segmentation mask comprises combining the plurality of segmentation masks using a genetic algorithm to satisfy the at least one rule.

4. The method of claim 1 further comprising obtaining a bounding box for the at least one image, wherein the bounding box defines a perimeter of an area of the at least one image which comprises the lesion, and wherein the plurality of segmentation masks are applied to the area defined by the bounding box.

5. The method of claim 4 wherein the at least one rule comprises a boundary constraint configured to ensure that the final segmentation mask is configured such that the final area defined by the final segmentation mask does not contact or intersect the perimeter of the bounding box.

6. The method of claim 1, wherein the at least one rule comprises a centroid proximity constraint configured to ensure that the centroid of a lesion segmented from the final mask is maintained within a defined distance relative to the centroid of the lesion segmented from at least one of the plurality of segmentation masks.

7. The method of claim 1, wherein
obtaining the at least one image comprises obtaining a plurality of images based on a scan of at least a part of a patient's anatomy, each image corresponding to a cross-sectional slice from the scan; and
repeating steps (b) to (d) for each of the plurality of images.

8. The method of claim 1 wherein generating the final segmentation mask comprises obtaining a similarity score configured to measure the similarity between the final segmentation mask and at least one of the plurality of segmentation masks; and wherein the at least one rule comprises a similarity score constraint configured to ensure that the obtained similarity score is above a predetermined threshold or within a predetermined range.

9. The method of claim 1, wherein the obtained at least one image is based on a scan of at least a part of a patient's lung.

10. The method of claim 9 wherein a first segmentation technique of the plurality of segmentation techniques is configured to generate a first segmentation mask to delineate parenchyma from other lung tissue, for example wherein the first mask is a Kmeans mask;
and wherein the at least one rule comprises a mask containment constraint, wherein the mask containment constraint is configured to ensure that the final segmentation mask must be confined within the area of the first mask.

11. The method of claim 1 wherein the plurality of segmentation masks comprises three different segmentation masks.

12. The method of claim 1, wherein the at least one rule comprises a centroid proximity constraint configured to ensure that the centroid of a lesion segmented from a second image is maintained within a defined distance relative to the centroid of the lesion segmented from a first image, wherein the first image and the second image are adjacent cross-sectional slices from the scan.

13. The method of claim 1, wherein the at least one rule comprises an area continuity constraint configured to
minimise area penalties, wherein area penalties are incurred for segmentation masks wherein the area of a lesion segmented from a second image is greater than the area of the lesion segmented from a first image, wherein the first image and the second image are adjacent cross-sectional slices from the scan, and wherein the first image is obtained closer to the centroid of the lesion than the second image.

14. The method of claim 1, wherein the at least one rule comprises a shape integrity constraint configured to ensure that irregular boundaries representing outgrowths in shape of a lesion segmented from an image are minimised, such that the shape integrity constraint is configured to promote smooth and regular lesion shapes segmented from an image.

15. The method of claim 1 further comprising determining the area of the lesion based on the segmented area of the at least one image.

16. The method of claim 1 wherein obtaining the at least one image based on a scan of at least a part of a patient's lung comprises obtaining a plurality of images, each image corresponding to a cross-sectional slice from the scan; and the method further comprising determining the volume of the lesion based on the segmented area of the lesion in each of the plurality of segmented images.

17. The method of claim 1 further comprising generating a three-dimensional model of the lesion based on the plurality of segmented images; and optionally determining the volume of the lesion based on the three-dimensional model of the lesion.

18. The method of claim 1, further comprising:
applying a weighting to each pixel within the segmented area of the at least one segmented image, wherein the weighting is based on the relative intensity of each pixel within the segmented area; and
determining an indication of mass of the lesion based on the weightings applied to each pixel within the segmented area of the at least one segmented image.

19. A computer readable non-transitory storage medium comprising a program for a computer configured to cause a processor to perform the method of claim 1.
